(19) United States
(12) Patent Application Publication
(10) Pub. No.: US 2017/0055510 A1
(43) Pub. Date: Mar. 2, 2017

(54) SIGNALING FISHING FLOAT

(71) Applicant: O. Spincer Harrell, Flora, MS (US)

(72) Inventor: O. Spincer Harrell, Flora, MS (US)

(21) Appl. No.: 14/834,820

(22) Filed: Aug. 25, 2015

(51) Int. Cl. A01K 97/12

(52) U.S. Cl. CPC A01K 97/125

(57) ABSTRACT

There is provided a fishing float comprising a buoyant, elongated body having first and second ends, a means for attaching a fishing line to the second end of the elongated body, and a lamp module attached to the first end of the elongated body. The lamp module is comprised of an elongated hollow watertight casing having first and second ends, with the ends of the lamp module being translucent and different colors such that a solar powered lamp fitted into the hollow casing of the module body can slide from the first to the second end whenever the module is tilted from a horizontal position to a vertical position by a fish pulling on the attached fishing line.

### TECHNICAL FIELD OF THE INVENTION

The present invention relates in general to fishing floats, and, in particular, to a fishing float that provides a visual signal when a fish is caught. More particularly, the present invention relates to a fishing float having a solar powered light that slideably gravitates from a first position to a second position when force is applied to a fishing line attached to one end of the fishing float.

### BACKGROUND OF THE INVENTION

Jugline fishing is a fishing technique that is commonly accomplished by securing a hook and line to a float or “jug” without the use of a pole. The “jug” can be any buoyant container, from an empty milk carton to a specially made jug-fishing device. A jugline fisher can place several jugs in the water at the same time, since, unlike pole-line fishing, the jugs do not require as much individual attention. A jugline fisher may chose to secure several jugs together or secure one or more jugs to an anchored object. A jugline fisher may chose to check each jug only periodically to determine if a fish has been caught. Compared to pole-line fishing, jugline fishing requires less attention for each line. Still, a jugline fisher must keep track of the location of each jug and then check each jug individually to determine whether a fish has been caught. A jugline fisher has the option to check the jugs more often or less often, comparatively. The less often the jugs are checked, the more likely a fish will be caught without being retrieved quickly—which increases the chances that a caught fish will be lost. Jugline fishing is often done at night. When fishing in low-light conditions, fishers benefit from a light indicating a fish is caught on the line.

In prior art devices, there are several ways for a fisher to determine when a fish has taken the bait on his jugline, including auditory and visual indications. An auditory indication can be difficult to detect when a fisher is far away from the jugline. Such circumstances are likely when a fisher has set multiple juglines over a large area. Also, the sound of the environment may inhibit a fisher's ability to detect an auditory signal.

Visual indicators are seen in a number of prior art inventions. Some disclose fishing floats with a battery connected in a series electrical circuit with a light bulb and a switch that closes the circuit upon a tug by a fish on the line to which the float is attached. Many of these inventions rely on a biasing means, such a spring, to hold the circuit open until a fish overcomes the biasing tension by pulling on the line, at which point the force applied by the fish causes movement of a mechanical means that closes the electrical circuit and thereby activates the light. It is common however that, after an initial period of intense struggle, a caught fish will move to a position that releases tension on the fishing line. When tension on the fishing line is relaxed, the biasing tension of springs in such inventions will cause the light to deactivate, even though a fish is caught and remains on the line. Also, the mechanical complexity of such inventions may make manufacture such devices costly.

Other visual indicators are seen in the prior art in the form of fishing floats that, while also including a battery connected in a series electrical circuit with a light bulb and a switch that closes the circuit upon the tug by a fish on the line to which the float is secured, these inventions rely on a mercury switch to close the circuit and thereby activate the light. Typically, these inventions present a bobber that is weight-biased to float in an inverted orientation (an orientation that places the light bulb downward and the other end of the bobber—the end to which the fishing line having a hook is connected—upward). When a fish pulls the hook and the attached line, tension on the line causes the bobber to change its orientation from a bulb downward to a bulb upward position. This rotation of the bobber in conjunction with gravity causes mercury in a container to flow from a first end of the container (with the circuit open) to a second end of the container, where the mercury closes the connection between open circuit connectors, thereby activating the light. However, if a caught fish releases tension on the fishing line, the weight biasing of the bobber allows it to return to its original position, thereby deactivating the light. Further environmental concerns and the mechanical complexity of such inventions make an improvement desirable.

Still other inventions have presented visual indicating fishing floats that, while also including a battery connected in a series electrical circuit with a light bulb and a switch that closes the circuit upon the tug by a fish on the line to which the float is secured, these inventions rely on gravity and the movement of a mechanical device to close the circuit and thereby activate the light when the float transitions from a horizontal or near horizontal position to a vertical position. In some cases, the mechanical device is a conductive ball that rolls into position to close electrical contacts and thereby activate a light. In others, the mechanical device is shaped to move or slide into a tailored position to close electrical contacts and thereby activate a light. Such floats provide no visual indication until a fish has pulled the float from horizontal to vertical positions.

While the above mentioned devices are directed to floats that illuminate when a fish is initially caught, there remains a need for a float that illuminates both before and when a fish is caught while being able to give a distinctive signal that differentiates when a fish has been caught, and that is simple and inexpensive to manufacture. Different colors in the visual indication enables the float to communicate two signals to a fisher, the first signal being the floats position even though unstruck by a fish, and the second signal being the float's position and that it has been struck by a fish. Inasmuch as the art is relatively crowded with respect to various types of illuminated fishing floats, it can be appreciated that there is a continuing need for and interest in improvements to illuminated fishing floats, and in this respect, the present invention addresses this need and interest.

### SUMMARY OF THE INVENTION

A signaling fishing float is disclosed. In accordance with one aspect of the invention, there is provided a fishing float comprising a buoyant, elongated body having first and second ends, with a lamp module attached to the first end of the elongated body, and a clip or similar means for attaching a fishing line to the second end of the elongated body. The lamp module is comprised of an elongated hollow watertight casing having first and second ends, with the ends of the lamp module being translucent and different colors such that a solar powered lamp fitted into the hollow casing of the module body can slide from the first end to the second end of the module body whenever the module is tilted from a horizontal position to a vertical position by a fish pulling on the fishing line attached to the second end of the float body. By the present invention, a fisher is given a visual indication of a first color when the float is in a horizontal position, and given a visual indication of a second color when the float is tilted into a vertical position.

A primary object of the present invention is to provide a fishing float that will give a fisher a first color visual indication of the float's location before a fish is caught and give a second color visual indication when a fish is caught.

It is another object of the invention to provide a fishing float that has a solar powered lamp, which will permit the power source to be recharged by simply exposing the fishing float to sunlight, and which will give the fishing float less mechanical complexity and make it less costly to manufacture.

Other objects, features and objectives of the invention will be found throughout the following description, the drawings and the claims.

### BRIEF DESCRIPTION OF THE DRAWINGS

For a more complete understanding of the features and advantages of the present invention, reference is now made to the detailed description of the invention along with the accompanying figures in which corresponding numerals in different figures refer to corresponding parts and in which:

FIG. 1 is a side view depicting an embodiment of the present invention in a horizontal position on a water body.

FIG. 2 is a cross sectional view of an embodiment of the present invention.

FIG. 3 is a cross sectional view of the lamp module of the present invention.

FIG. 4 is a side view of the lamp module of the present invention.

FIG. 5 is a side view depicting an embodiment of the present invention in a vertical position on a water body.

### DETAILED DESCRIPTION OF THE INVENTION

For a more complete understanding of the features and advantages of the present invention, reference is now made to the detailed description of preferred embodiments of the invention along with the accompanying figures in which corresponding numerals in different figures refer to corresponding parts and in which:

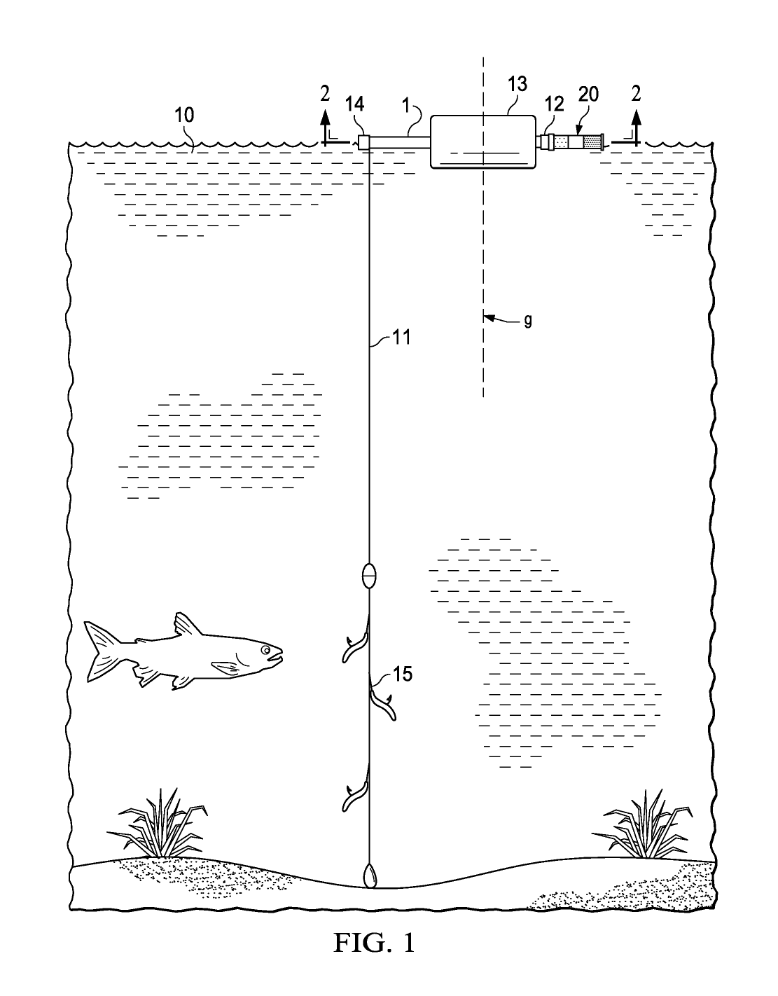

Illustrated in FIG. 1 is the jugline fishing float of the present invention shown floating on the surface of a water body 10 while connected to a fishing line 11. Fishing line 11 is shown relatively taut as supporting the weight of the hook 15, bait or lure, leader, and any fishing weights that may be attached to the line, but not sufficient weight to tip the float from its relatively stable horizontal orientation.

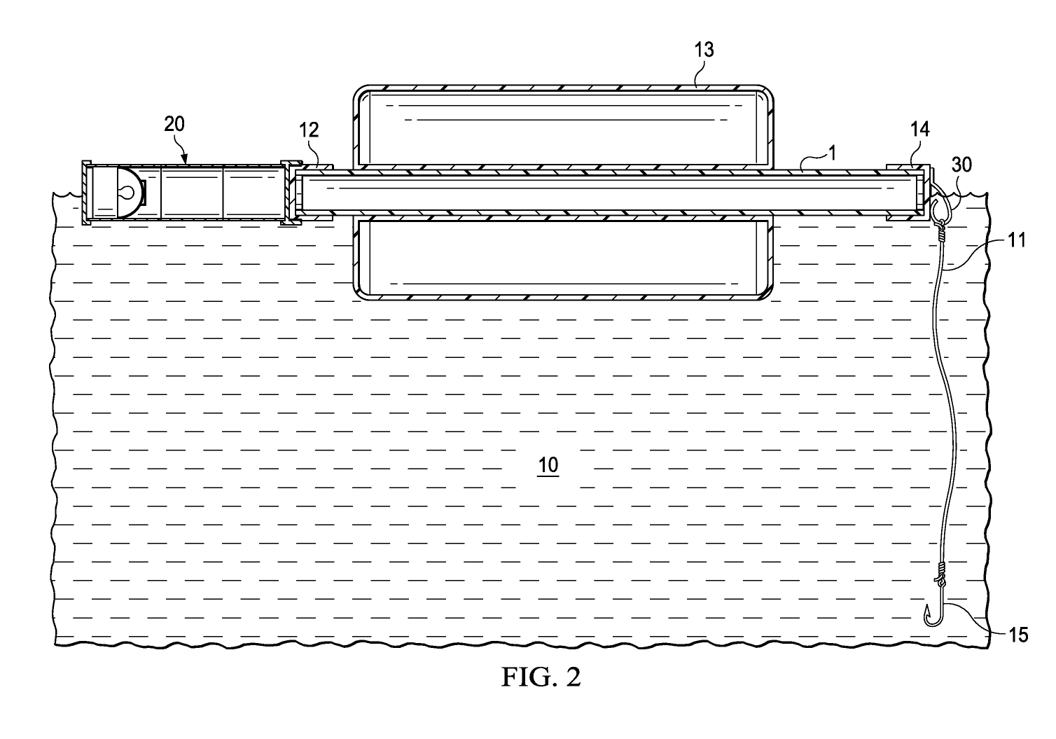

As can be seen in FIG. 2, the fishing float of the present invention is comprised of an elongated body 1 having a first body end 12 and a second body end 14. The float is further comprised of a floatation support 13, and a lamp module 20. The fishing float may have a clip 30 or eyelet or similar means for securing a fishing line to second body end 14. Lamp module 20 may be attached to elongated body 1 at or in proximity to first body end 12.

Elongated body 1 may be of any shape (e.g. quadrangular, hexagonal, etc.), though in the preferred embodiment, it is cylindrical in shape. Elongated body 1 may be made of any material, including polyvinyl chloride pipe or similar buoyant material. Buoyancy of the fishing float may be provided by the buoyancy of elongated body 1, the buoyancy of floatation support 13 or a combination of the buoyancy of elongated body 1 and floatation support 13. Floatation support 13 may be of any shape and attached to elongated body 1 at any location, though in the preferred embodiment floatation support 13 is cylindrical shaped and attached around elongated body 1. Floatation support 13 may be made of any buoyant material, such as closed cell foam or extruded polystyrene foam; and floatation support 13 may be of such size to accommodate the size of fish a fisher desires to attract.

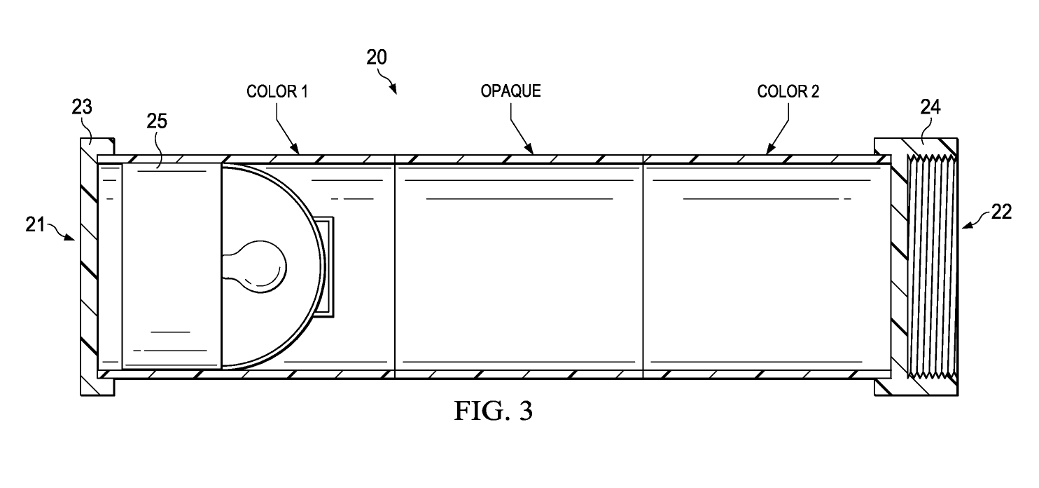

As can be seen in FIG. 3, lamp module 20 may be comprised of an elongated hollow casing having a first module end 21 and a second module end 22 with end caps 23 and 24, which hollow casing and end caps form a buoyant, watertight compartment. Inside the watertight hollow casing of lamp module 20, a solar powered lamp 25 is configured to be slideable between first module end 21 and second module end 22.

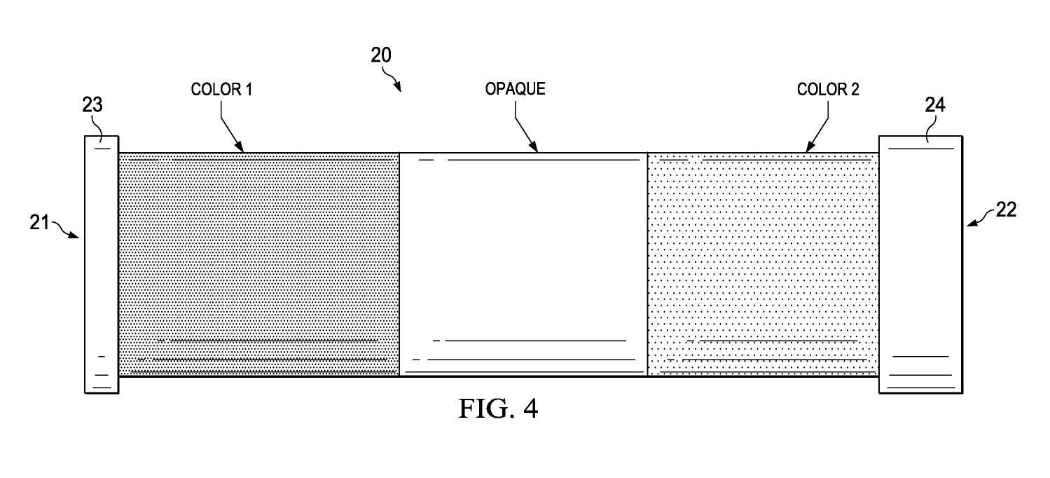

It will be appreciated that lamp module 20 may be attached inside or on the exterior of elongated body 1 in proximity to first body end 12. It will be further appreciated that the elongated hollow casing of lamp module 20 may be made of translucent or transparent material such that light from solar powered lamp 25 may be observed from outside lamp module 20 when solar powered lamp 25 is placed inside the elongated hollow casing of lamp module 20. As can be seen in FIG. 4 the elongated hollow casing of translucent material may be colored with a first color on first module end 21 and a second color on second module end 22.

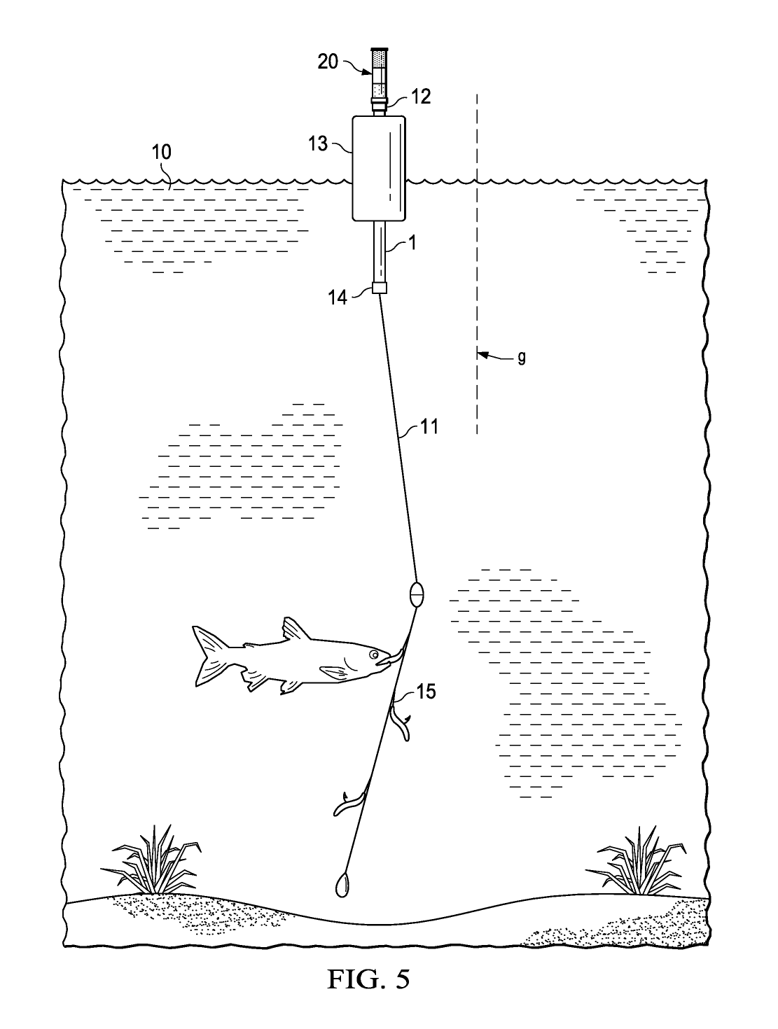

In use, the present invention will be placed to initially float on the surface of a water body in a horizontal orientation, as seen in FIG. 1 and FIG. 2. As the present invention floats in a horizontal orientation, solar powered lamp 25 will rest in the first module end 21 of lamp module 20 presenting the fisher with a visual indication of a first color. The visual indication given in the horizontal orientation will provide the fisher with a convenient method of locating the fishing float in low light conditions when a fish has not struck the bait on the jugline. When a fish strikes the hook 15 on line 11, downward force on line 11 will translate into downward force on the second body end 14 of elongated body 1, which will cause elongated body 1 to rotate toward a vertical orientation, as seen in FIG. 5. Gravity in conjunction with said rotation of elongated body 1 will cause solar powered lamp 25 to slide from the first module end 21 to second module end 23. When solar powered lamp 25 is positioned in second module end 23, the present invention will give the fisher a visual indication of a second color. In such circumstances, a jugline fisher who returns to check jugs will observe the present invention illuminated with the second color, thus communicating to the fisher that the fishing float has been struck by a fish and rotated into the vertical position. With the solar powered lamp being the light source for the fishing float, the fisher can recharge the power source for the float's light by simply exposing the fishing float to sunlight between fishing events.

In all cases in this specification and in the claims attached hereto, references to a solar powered lamp in the context of the present invention is intended to include any solar powered integrated electrical or electronic device that reliably produces light when an appropriate voltage is applied to appropriate terminals thereof. Solar powered lamps are well known and commercially available. In the preferred embodiment, a Westinghouse™ Model 577105 is used for solar powered lamp 25.

While various embodiments of the invention have been described, the description is intended to be exemplary, rather than limiting and it will be apparent to those of ordinary skill in the art that other embodiments and implementations are possible that are within the scope of the invention. Accordingly, the invention is not to be restricted except in light of the attached claims and their equivalents.

The invention claimed is:

1. A fishing float comprising:
an elongated body having a first body end and a second body end;
a connecting means for connecting a fishing line to said second body end;
at least one lamp module attached to said elongated body at said first body end, said at least one lamp module comprising:
an elongated hollow watertight casing having first and second module ends, with said first module end being semi-translucent first color and said second module end being semi-translucent second color; and
a solar powered lamp inside said elongated hollow casing of said lamp module, said solar powered lamp sizeably engaged with said elongated hollow casing such that the solar powered lamp slidably gravitates from said first module end to said second module end when the fishing float is tilted from a horizontal position toward a vertical position.

2. The fishing float of claim 1 having a flotation support attached to said elongated body.

3. A fishing float comprising:
an elongated body having a first body end and a second body end;
a flotation support attached to said elongated body;
a connecting means for connecting a fishing line to the second body end;
at least one lamp module attached to the elongated body at said first body end, said at least one lamp module comprising:
an elongated hollow watertight casing having first and second module ends, with said first module end being semi-translucent first color and said second module end being semi-translucent second color;
a solar powered lamp inside said elongated hollow casing of said lamp module, said solar powered lamp sizeably engaged with said elongated hollow casing such that the solar powered lamp slidably gravitates from said first module end to said second module end when the fishing float is tilted from a horizontal position toward a vertical position.

4. A fishing float comprising:
an elongated buoyant body having first and second body ends;
a connecting means for connecting a fishing line to said second body end;
at least one lamp module attached to said elongated body at said first body end, said at least one lamp module comprising:
an elongated hollow watertight casing having first and second module ends, with said first module end being semi-translucent first color and said second module end being semi-translucent second color; and
a solar powered lamp inside said elongated hollow casing of said lamp module, said solar powered lamp sizeably engaged with said elongated hollow casing such that the solar powered lamp slidably gravitates from said first module end to said second module end when the fishing float is tilted from a horizontal position toward a vertical position.
